(19) United States
(12) Patent Application Publication
(10) Pub. No.: US 2005/0088320 A1
(43) Pub. Date: Apr. 28, 2005

(54) System for registering and tracking vehicles

(76) Inventor: Aram Kovach, Lewis Center, OH (US)

Correspondence Address: MICHAEL A. FORHAN, ELEY LAW FIRM CO., P.O. BOX 340557, COLUMBUS, OH, 43234-0557, US

(21) Appl. No.: 10/961,795

(22) Filed: Oct. 8, 2004

Related U.S. Application Data
(60) Provisional application No. 60/509,632, filed on Oct. 8, 2003.

(51) Int. Cl. G08G 1/01

(52) U.S. Cl. 340/933; 340/932.2

(57) ABSTRACT

A system for registering and tracking vehicles. The system comprises an RFID tag affixed to a vehicle and a scanner, wherein the scanner is adapted to query the RFID tag when proximate the RFID tag, effective to obtain information relating to at least one of the vehicle and an owner of the vehicle. In another embodiment the system may be employed with parking meters to detect parking violations and issue citations. In other embodiments the system may be employed to track the speed of vehicles, halt traffic to allow emergency vehicles to pass, provide pass code access to objects and secured areas, and track the location of objects and personnel. A method employs the system.

This application claims priority to U.S. provisional application No. 60/509,632, filed Oct. 8, 2003, the contents of which are hereby incorporated by reference.

### FIELD

This invention relates to a system for registering, identifying and tracking the location of motor vehicles. Specifically, the invention relates to a system for registering, tracking and monitoring vehicles within a political subdivision or jurisdiction or among cooperating jurisdictions.

### BACKGROUND

Urban growth has resulted in a substantial increase in the number of registered vehicles. Each vehicle is typically required by a political subdivision, such as a state, to undergo an annual safety inspection and license re-registration. A goal of this process is to keep unsafe vehicles off the roads and to maintain current ownership information for the vehicles. There is a desire to make the process for registering and re-registering vehicles as efficient as possible, in order to minimize inconvenience to vehicle owners and maximize the revenue that political subdivisions derive for providing such services. Currently, major metropolitan cities face daunting challenges in registering and re-registering vehicles because the only practical way that it can be determined if a vehicle registration has expired is by a visual check of the vehicle's license plates, or by carrying out a registration check of the vehicle license plate number and/or Vehicle Identification Number (“VIN”) against a database maintained by a law enforcement entity.

The process of ticketing parking violators is equally daunting, given the number of parking spaces in a typical major metropolitan city. A parking meter associated with each parking space must be visually checked by law enforcement personnel to determine if the time allotted by the meter has expired. If the meter has expired, law enforcement personnel must make a visual inspection of the vehicle to obtain the license number and/or VIN and write out a parking citation. Furthermore, the collection of coins from parking meters is cumbersome. Attendants are tasked with collecting the deposited coins in each parking meter and then transporting them to a central location to be counted. This method of collecting parking fees is inefficient.

In addition, there is a constant need to monitor traffic pattern movements and the speed of vehicles, particularly in high-risk areas such as construction zones, school zones and residential areas. This is difficult and time-consuming, as each of these scenarios presently require the presence of a law enforcement officer.

Because of the labor-intensive nature of enforcing existing vehicle registration and traffic laws and the magnitude of the effort, a large number of potential citations and re-registration fees go uncollected each year, contributing to decreased traffic safety and a corresponding loss of revenue to the responsible jurisdiction. Similarly, current enforcement systems and methods are prone to human errors and misidentification. For example, it is not uncommon for the person writing a citation to transpose or leave out digits in a license plate or VIN number, making subsequent tracking of the status of the citation and enforcement of the citation difficult and labor-intensive.

A long-recognized problem with the current vehicle registration system is its cumbersome nature wherein a vehicle owner is required to wait in line for lengthy periods of time at a registrar's office for a re-issuance of a paper document evidencing re-registration of the vehicle. Consequently, some vehicles go unregistered and continue to be driven at the expense of safety and the public coffers. Further, when new vehicle license plates are issued, there is no way for the registrar to ensure that the registrant is installing the new license plates on the vehicle for which they were issued. License plates may also be lost or stolen and end up on vehicles to which they do not belong, perhaps in an effort to cloak criminal activity.

As workforce labor and other overhead expenses rise, there is an increasing need to improve the collection efficiency of violations and minimize the number of employees needed to accomplish this task. Government offices are continually under budget constraints and are constantly seeking to streamline their operation to cut costs and increase revenue. One such activity is taking regular inventory of the registered vehicles within a given jurisdiction. This is often accomplished using a mass mailing to prior registrants who may have moved or who have not returned for a re-registration of their vehicles. If caught, these individuals often only face an economic sanction for their offense. Regular inventorying is needed for budgetary purposes and to facilitate ordering of replacement tags or re-registering an existing vehicle.

Another concern involves a type of theft called “pilfering” in which an employee working within the vehicle registration system steals license plates and provides them to criminal elements. Pilfering is particularly troublesome since dishonest employees are usually aware of security precautions that are in place and how to avoid detection. An even more serious form of theft involves stolen vehicles, where many such vehicles are quickly disassembled and resold as parts. Consequently, locating a stolen vehicle within a short timeframe is crucial to its recovery.

There is also a need for a more robust and reliable means of tracking the movement of people and vehicles. There is a further need to streamline vehicle registration and to automate the vehicle re-registration process. Yet another need exists to more efficiently enforce existing traffic laws, increase traffic safety and collect all fines and penalties resulting from traffic and parking violations.

### SUMMARY

The present invention provides a system for monitoring and tracking vehicles using integrally-mounted Radio-Frequency Identification (“RFID”) tags. The RFID tag typically contains an electronic microchip, which may be permanently attached to either a flexible or rigid substrate containing a small antenna, or environmentally sealed in a housing. Each RFID tag can be tuned to operate at a specific frequency that is optimal for the application and programmed with a unique identifying number. In addition, the tag may be programmed remotely with ancillary information, such as a vehicle's VIN number, license issue date, physical appearance or other identifying information, and ownership information. Alternatively, the same information may be stored in a remote database and associated with the unique RFID tag identifier for later retrieval.

The microchip on the RFID tag is “queried” and then read by an external “scanner” device by means of a radio frequency (“RF”) field emitted by the scanner. The RF field also provides a means for transmitting tag-specific data to be stored within a memory portion of the microchip if, desired. The memory portion may be static, thus eliminating the need for batteries.

An RFID tag used for the vehicle identification in one embodiment of the invention is an “active” tag designed to regularly transmit a data signal containing the tag's unique identifier. In other embodiments a “passive” RFID tag may communicate the RFID tag's identifier number and any data stored on the microchip to a receiver portion of the scanner only when interrogated by an external reader.

An aspect of the present invention is a system for registering and tracking vehicles. The system comprises an RFID tag affixed to a vehicle and a scanner. The scanner is adapted to query the RFID tag when proximate the RFID tag, effective to obtain information relating to at least one of the vehicle and an owner of the vehicle.

Another aspect of the present invention is a system for tracking vehicles. The system comprises an RFID tag affixed to a vehicle and a parking meter having a scanner. The scanner is adapted to query the RFID tag when proximate thereto, effective to obtain information relating to at least one of the vehicle and an owner of the vehicle. The parking meter generates a citation if the vehicle remains proximate the scanner after a predetermined period of time has elapsed.

Yet another aspect of the present invention is a method for registering and tracking vehicles. The method comprises the steps of coding an RFID tag with a unique identifier, integrating the RFID tag with a vehicle, creating a database with a record of information relating to at least one of the vehicle and an owner of the vehicle, associating the record with the unique identifier, querying the vehicle's RFID tag with a scanner to obtain the unique identifier, using the unique identifier to obtain the record, and responding to the query with information in the record.

Still another aspect of the present invention is a method for tracking objects. The system comprises an RFID tag affixed to an object and a scanner. The scanner is adapted to query the RFID tag when proximate the RFID tag, effective to obtain information relating to the object.

Another aspect of the present invention is a method for displaying targeted information. The method comprises the steps of coding an RFID tag with a unique identifier, integrating the RFID tag with a vehicle, creating a database with a record of information relating to at least one of the vehicle and an owner of the vehicle, associating the record with the unique identifier, querying the vehicle's RFID tag with a scanner to obtain the unique identifier, using the unique identifier to obtain the record from the database, comparing information in the record with related information in an algorithm, selecting display data relevant to at least one of the vehicle and the owner based on the comparison, and displaying the selected data on a display visually perceivable by the owner.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a top view of a police vehicle in the vicinity of a number of passenger vehicles, showing query signals being emitted and received by the police vehicle according to an embodiment of the present invention;

FIG. 2 is a close-up view of a police vehicle and a passenger vehicle, showing RFID tag query signals being emitted and received by the police vehicle to obtain information relating to the passenger vehicle according to an embodiment of the present invention;

FIG. 3. is a view of the present invention employed in connection with a roadway in which RFID-equipped vehicles may be identified, tracked and clocked to determine their speed of travel, according to an embodiment of the present invention;

FIG. 4 is view of the present invention employed with a parking meter to detect the presence, identity and parking duration of a parked vehicle equipped with an RFID tag, according to an embodiment of the present invention;

FIG. 5 is a block diagram of a method for registering and tracking vehicles according to an embodiment of the present invention;

FIG. 6 is a block diagram illustrating an RFID-equipped vehicle being identified using a remote database and a telecommunication link according to an embodiment of the present invention; and

FIG. 7 is a block diagram illustrating an RFID equipped vehicle being identified using a database located in a police vehicle and using cellular technology according to an embodiment of the present invention.

### DETAILED DESCRIPTION

The present invention utilizes conventional RFID tags integrated with vehicles and/or vehicle owners, and “scanner” devices adapted to perform such functions as transmit RF signals to the RFID tags, provide electrical power to the tags, write data to the tags for storage, and read stored data from the tags. An example active RFID tag is the TG800—ASSET TAG® RFID tag provided by Wavetrend Technologies Ltd. of Johannesburg, South Africa. An example passive RFID tag is the DURA-LABEL™ RFID tag provided by Neology of San Diego, Calif. However, the type of RFID tag or scanner is not critical to the operation of the present invention. Thus, RFID tags and associated systems manufactured by others may likewise be utilized with the present invention.

The scanner is able to simultaneously read the information from a multitude of RFID tags in a group, eliminating the need to individually scan vehicles passing by a scanner portal. Thus, information relating to multiple RFID-equipped vehicles can be gathered without impeding traffic flow.

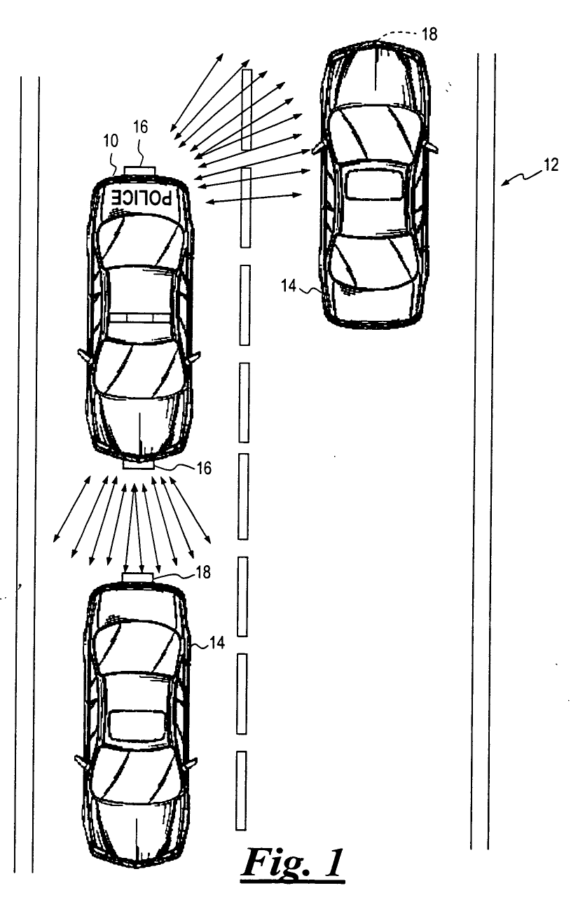

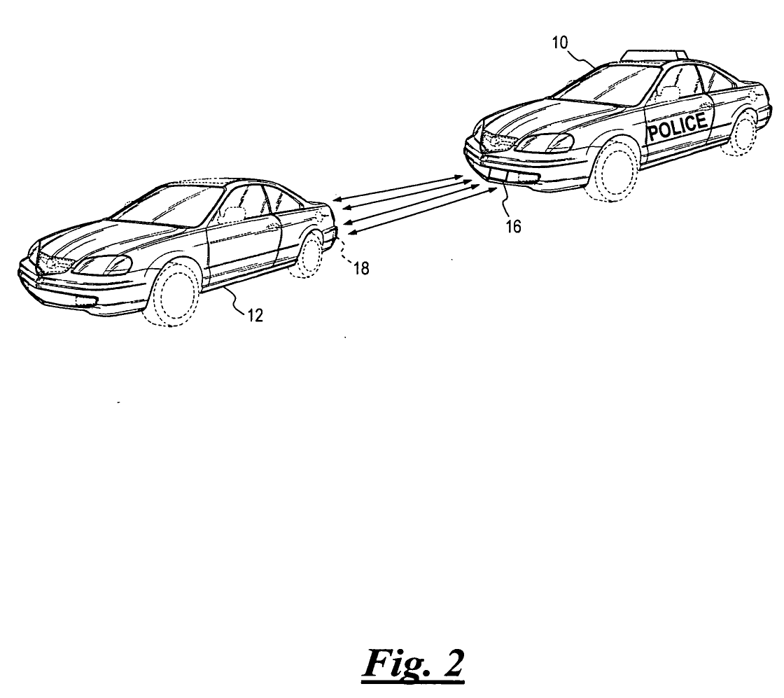

FIGS. 1 and 2 depict an overview of an aspect of the present invention. A police vehicle 10 traveling on a road 12 encounters other vehicles 14 on the road. Police vehicle 10 may have one or more scanners 16 installed on the police vehicle and positioned to scan, or “query” an RFID tag 18 integral to a vehicle 14 proximate the police vehicle. The query comprises an RF signal emitter by scanner 16 and received by RFID tag 18. In response, RFID tag 18 transmits an RF signal to scanner 16, the RFID signal containing pre-programmed data such as a unique identifier number and ancillary data, such as vehicle and owner information. A conventional display (not shown) mounted in police vehicle 10 displays information associated with RFID tag 18, in a manner described in greater detail below.

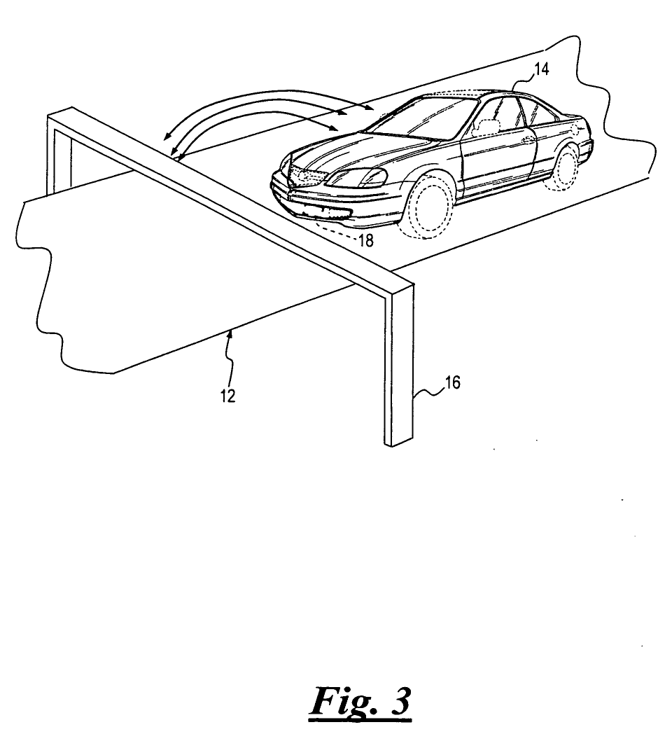

FIG. 3 illustrates an alternate embodiment of the present invention. A scanner 16 is located proximate road 12. Scanner 16 may be in the form of a generally U-shaped grid surrounding road 12, as shown in FIG. 3, or may be made part of conventional traffic signals or information signs mounted over or beside the road. As a vehicle 14 passes proximate scanner 16, RFID tag 18 is queried by the scanner. Information obtained from RFID tag 18 by scanner 16 may be transmitted to a remote site (not shown), such as a police station, for analysis. The information may be transmitted by any conventional telecommunication link including, without limitation, wired or wireless internet, PSTN, PBX and cellular telephone, and terrestrial and satellite-based high-speed data networks, electronic computer networks and data buses. Likewise, the vehicle's RFID tag information may be manually reviewed by personnel located near scanner 16 or at the remote site, or may be automatically reviewed, as discussed in greater detail below.

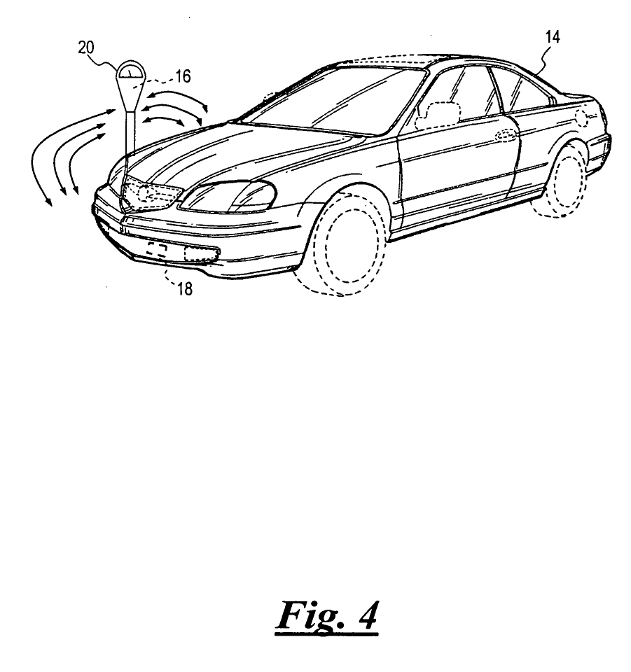

FIG. 4 depicts an overview of another embodiment of the present invention. A vehicle 14 is parked at a metered parking space monitored by a parking meter 20. The driver of vehicle 14 parks proximate to meter 14 in any conventional manner, such as parallel parking or head-in parking. The driver pre-pays parking meter 20 in the conventional manner, for a predetermined amount of parking time. If the time on meter 20 expires before the driver returns, the meter, which includes a scanner 16, reads an RFID tag 18 mounted integral to vehicle 14. The amount of time vehicle 14 exceeds the paid parking time is recorded by meter 20. After vehicle 14 exits the parking space, meter 20 stores in a local or remote memory portion the parking violation information (i.e., post-expiration parking time) and vehicle data obtained by scanning RFID tag 18. The parking violation information and vehicle data may be transmitted to a remote site via the telecommunication link described above, and analyzed manually or automatically to issue a parking citation to the vehicle owner.

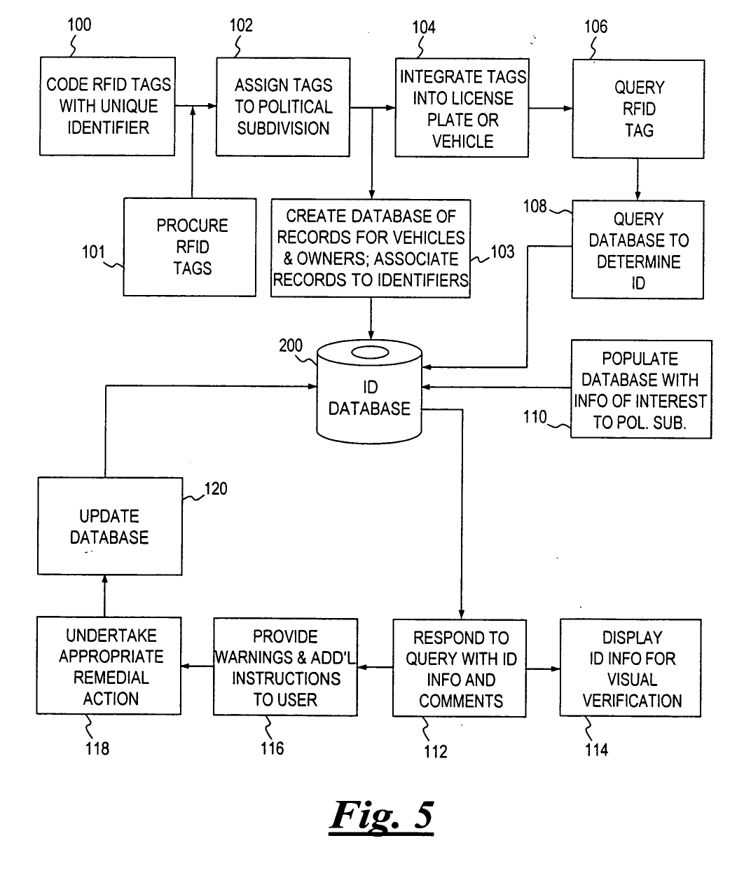

A block diagram of a system for registering and tracking vehicles is shown in FIG. 5. At step 100 an RFID tag is coded with a unique identifier, such as a numeric or alphanumeric string. The RFID tag may be procured, as at step 101, or may be made an integral part of a vehicle. A block of RFID tag numbers is then assigned a political subdivision (such as a state) for use in performing a particular function, such as law enforcement, at step 102. At step 104 the tags are integrated into each vehicle (if not already integrated) or applied onto the vehicle license plate which is to be attached to a vehicle. Collaterally, the RFID tag identification number may be accessed from without the political subdivision and used to obtain the vehicle and/or owner information by non-law enforcement agencies for other purposes.

At step 103 the RFID-tagged vehicle may be scanned and the resulting information inventoried in a central database 200 as the vehicle encounters various predetermined checkpoints. For example, stationary scanners can be set up at intersections or at bridges to scan traffic that passes through major traffic arteries (see generally FIGS. 3 and 5). Upon arrival at another scanning station the vehicle can be identified and tracked as it passes through a scanning device at step 106 which reads the RFID tags' identifier numbers. The scanners can be positioned in geographically dispersed positions throughout the world. The vehicle may thus be identified and tracked at step 108 as it is placed into any predetermined location, such as a parking area, parking garage, or taken to a pick-up or drop-off portion of a facility. If appropriate, scanners may be deployed at key traffic locations within a city to re-trace the location-history of the vehicle prior to leaving the city limits. This may be helpful in alerting law enforcement personnel as to the prior locations of the vehicle in relation to its current position within the city, aiding police investigators to place suspicious vehicles near a crime scene, for example, or to clear innocent suspects.

As previously noted, the RFID tag is small and quite rugged. As such, it may be made an integral part of a vehicle, its license plate or window sticker. For personal identification, it can be applied to or incorporated within a plastic credit type card. With respect to FIG. 5, when a RFID equipped visitor enters the government office at step 106, a scanner placed at the entrance can detect the RFID enabled card being carried by the visitor at step 108 and reads the identifier number and any other pertinent information residing on the card. This data is sent to database 200 at step 108, which matches the identifier number to a record. The record may include such information as, without limitation, criminal history, security clearance information, credit account numbers, vehicle insurance information, blood type, medical history, allergic reactions to medicine or any other personal information. Database 200 may be a standalone unit operating autonomously, as in the case of parking meters (see FIG. 4) which can be solar powered and/or self contained with their own power source and connecting periodically to transfer collected RFID tag information to database 200 using the previously-described telecommunication link. Alternatively, database 200 may be part of an internal and/or external network of computers.

Data of interest to a political subdivision, such as owner biometrics, e.g., compared images, fingerprints and DNA sequences, may be stored in searchable records within database 200, as at step 110. The data in the records can be used, for example, to search for and report on anomalies found at the scene of an accident, crime or other incident.

Information read by scanners at step 108 may be automatically transmitted to database 200, which responds at step 112 to the query, identifying and tracking vehicles equipped with RFID tags. A display or computerized voice messaging system may be utilized at step 114 or 116 to inform or warn the user of any emergency or issues, notifications or additional instructions by the authorities at any connected node on a network or telecommunication link.

Thus, FIG. 5 illustrates a method for registering and tracking vehicles. The method includes the steps of coding an RFID tag with a unique identifier at step 100, integrating the RFID tag with a vehicle at step 104, creating a database with a record of information relating to at least one of the vehicle and an owner of the vehicle at step 103, associating the record with the unique identifier at step 103, querying the vehicle's RFID tag with a scanner to obtain the unique identifier at step 106, using the unique identifier to obtain the record at step 108, and responding to the query with information in the record at step 112.

In other embodiments of the present invention vehicles equipped with RFID tags can be monitored over a stretch of highway or road by placing stationary scanning units at known geographic locations. The present invention allows for distance calculations and traffic speeding issuance procedures from a batch process which analyzes all traffic which passes between scanners at fixed distances as either calculated or assigned by their configuration in the system (see generally FIGS. 3 and 5). Each scanner can be equipped with a telecommunication link and a satellite global positioning system (“GPS”), allowing the present invention to automatically compute speeding violations and issue citations when such activity is observed between fixed scanners. The issued citations can flow through the telecommunication link as a web-based on-line transaction. Vehicle owners can be notified by post, email or text messaging to a telephone number or email address which is on file in database 200 (see FIG. 5) when a violation is processed. In this way high-risk areas such as construction zones, school zones and residential areas can be constantly and automatically monitored with little or no oversight by enforcement personnel. In this embodiment the present invention is also useful for monitoring traffic flow patterns.

With continued reference to FIG. 5, vehicle re-registrations can be assessed directly to an owner's financial account, such as a credit or debit card account, using the registration process obtained at step 103. The individual may optionally be provided with a printed receipt at this step in the process.

When a vehicle inspection occurs, the present invention can track and store in the RFID tag and/or database 200 the time the vehicle is the inspection facility, the identity of who worked on it, and what work was performed. The present invention can also, at the time of the inspection, bill any previously-issued citations that have accumulated for the identified vehicle if the credit card on file is not valid or not chargeable. When the vehicle exits the facility, scanners placed at the entrance and exit can detect the RFID tag and note the time the vehicle spent in service for the issuance of the RFID-enabled vehicle tags.

With continued reference to FIG. 5, RFID tags can be categorized in database 200 as “stolen” at step 120. When an RFID tag having a “stolen” classification in database 200 is detected at step 106 by either stationary or police car mounted scanners, an audible alarm in the police car or notification to authorities can be issued at step 116. The vehicle can be located at step 118 based on the known location of the scanner of step 106, allowing law enforcement personnel to recover the vehicle at step 118 and possibly apprehend the thief. At step 120 the status of the RFID tag associated with the vehicle may be updated to remove the “stolen” classification after the car is returned to its rightful owner.

As can be seen, the disclosed method provides a more efficient and accurate means for issuing monitoring and tracking vehicles within a political subdivision such as a city or a country. Likewise, installing the RFID tag into traceable equipment, such as equipment, provides officials with a new tool for facilitating faster asset tracking, by pairing personnel and employees with assets they are authorized to use, automatically logging the movement of controlled equipment and other items between predetermined locations and further automating inventory management, all while also preventing theft.

There is a particular desire to minimize losses due to theft, fraud and circumvention of parking metering systems. One of the most common types of violations is that of exceeding the pre-paid parking time at a parking meter, wherein a vehicle owner parks at a parking meter and returns to the vehicle after his time has run out, but escapes payment for the excessive time used because the violation has not been visually detected by law enforcement personnel. With reference again to FIG. 5, at steps 100-104 the RFID tag is associated with and integrated to a vehicle in the manner previously described. At step 110 the unique identifier number of the RFID tag may be associated with the vehicle owner's financial account, such as a credit or debit card account. In the event that the vehicle is tracked at step 112 while violating local laws, such as parking beyond the time paid for at a metered parking space, the vehicle owner's account can be directly charged at step 118 in the amount of the prescribed fee for the violation. This ensures that the political subdivision will collect the fine, and reduces the amount of personnel required to enforce such violations.

According to one embodiment of the invention, when a vehicle is parked at a parking meter the appropriate funds are initially debited from the owner's credit or debit card at steps 106-110 for a time selected at the meter by the owner. If the parking time is exceeded, the violation is automatically detected by the parking meter at step 112. The parking fine can be issued and simultaneously collected by the present invention at step 118 without any additional human interaction. Optionally, the vehicle owner, using a cellular telephone or other telecommunication link, can authorize at step 120 payment of additional fees if additional parking time is desired, up to a predetermined maximum allotted time limit.

To hold the owners of vehicles more accountable or for insuring the identification of a driver during a traffic stop, the present invention provides at step 103 for storage in a remote database of vehicle- and owner-specific information, such as a vehicle metrics (i.e., make, model, VIN, color, options) as evidence that the identified RF tag is associated with the properly assigned vehicle and owner. Additionally, the present invention may be configured to include a vehicle owner's biometric identification, such as gender, height, weight, eye color, driver license photograph, voiceprint or thumbprint, as part of the remotely stored vehicle-specific data. In this regard, the driver of an identified vehicle can be visually compared to the owner's biometric information associated with the vehicle's unique identifier. As even a further security enhancement, the present invention provides for embedding small, passive RFID tags directly into a driver's license with each RFID tag providing a unique, tamper-proof code assigned specifically to whom the driver's license is issued. The present invention can then use this driver's license RFID tag to verify the identity of an individual, and the validity of their identification by comparing their physically observed biometric parameters to those recalled from a database record corresponding with identity of the RF tagged driver's license.

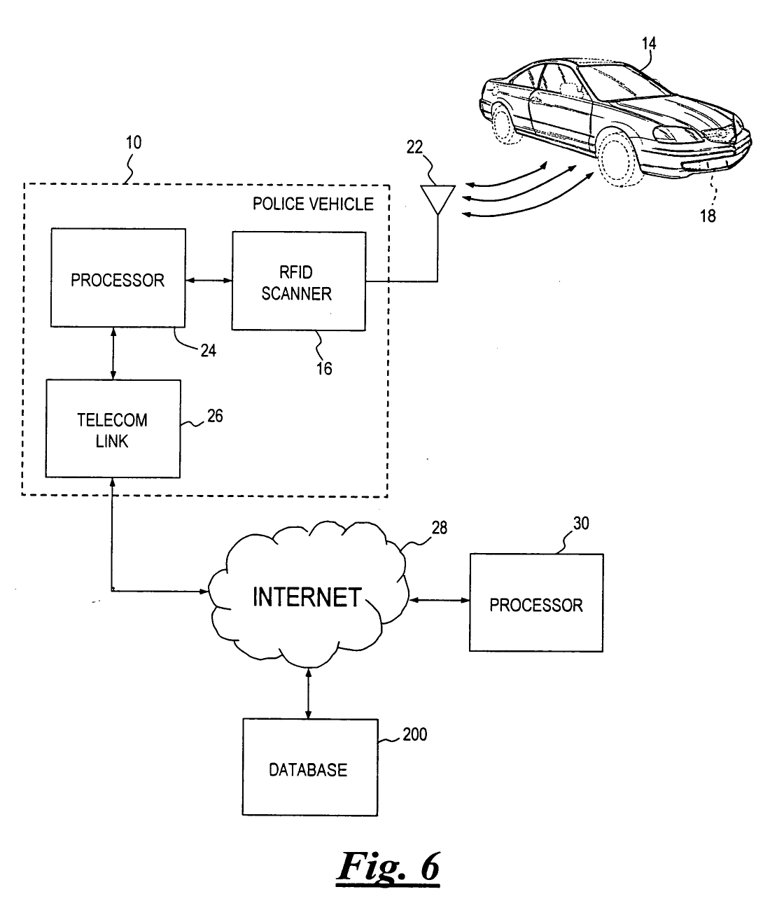

With continued reference to FIG. 5, FIG. 6 depicts a block diagram of an example embodiment of the present invention installed in a police car 10. Police car 10 has at least one RFID tag scanner 16 installed with an antenna 22 aimed such that the scanner is able to transmit to, and receive data from, an RFID tag 18 affixed to a vehicle 14 proximate the police car. A processor 24 installed in police car 10 receives the RFID tag information from scanner 16 and forwards the information to database 200 via a telecommunication link 26, which may be connected to the internet 28. Database 200 may be automatically queried by processor 24 in the manner of FIG. 5, or may be queried manually by personnel in police vehicle 10. In some embodiments a second processor 30 may be connected to telecommunication link 26, 28 to review RFID tag 18 data and any associated records, warnings and information present at steps 112-116 of FIG. 5. Some or all of scanner 16 and processors 24, 30 may include a visually perceivable display, allowing personnel to see the RFID tag data and any associated records in database 200.

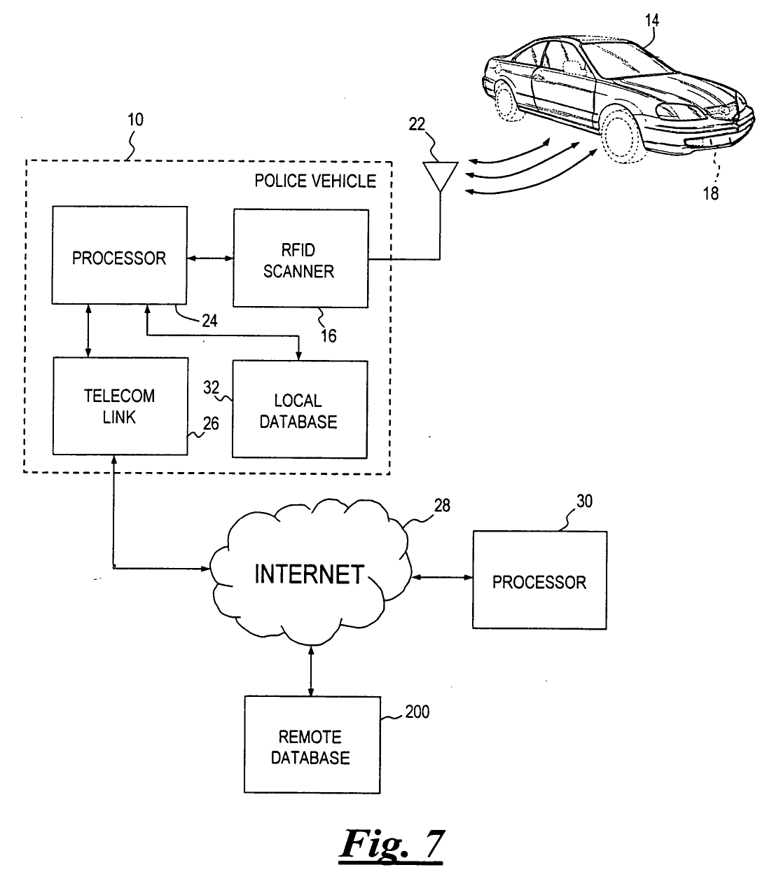

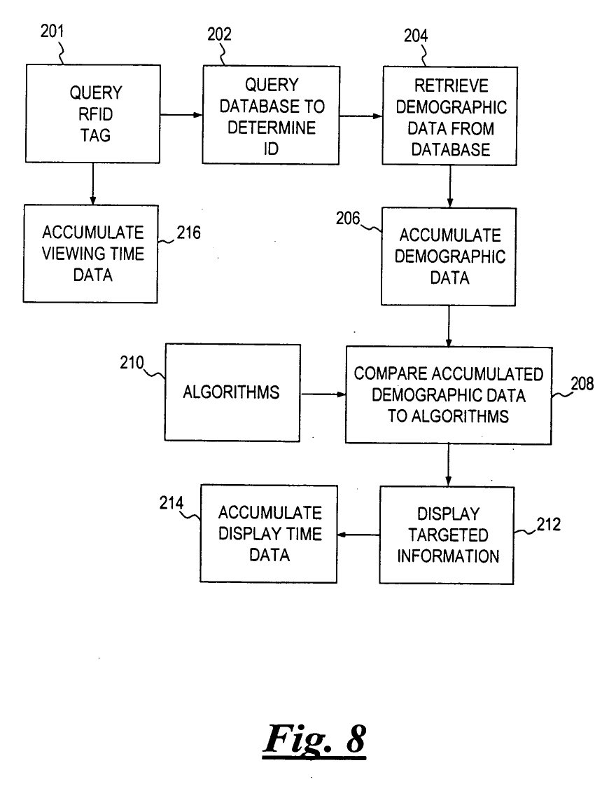

With continued reference to FIG. 5, FIG. 7 depicts a block diagram of another example embodiment of the present invention installed in a police car 10. Police car 10 has at least one RFID tag scanner 16 installed with an antenna 22 aimed such that the scanner is able to transmit to, and receive data from, an RFID tag 18 affixed to a vehicle 14 proximate the police car. A processor 24 installed in police car 10 receives the RFID tag information from scanner 16 and queries a local database 32 installed within the police car and/or a remote database 200. This embodiment has the advantage of a typically faster response from local database 32 than from remote database 200 to queries for records associated with RFID tag 18, and eliminates or lessens the dependency on communication link 26, 32. Optionally, processor 24 may additionally forward the RFID tag information to a remote database 200 via telecommunication link 26, which may be connected to the internet 28. Database 200 may be automatically queried by processor 24 in the manner of FIG. 5, or may be queried manually by personnel in police vehicle 10. In some embodiments a second processor 30 may be connected to telecommunication link 26, 28 to review RFID tag 18 data and any associated records, warnings and information present at steps 112-116 of FIG. 5. Some or all of scanner 16 and processors 24, 30 may include a visually perceivable display, allowing personnel to view the RFID tag data and any associated records in database 200.

In embodiments in connection with emergency vehicles, RFID tags may be installed in order to trigger traffic controls. For example, traffic signals can be fitted with scanners configured to detect the presence of RFID tags which have been encoded with an emergency vehicle identifier. As the vehicle approaches the scanner and is identified as an emergency vehicle, the traffic control can switch the traffic signal to its emergency mode, e.g., four-way red signal, thereby stopping traffic from traversing an intersection. If the lights are in communication with a control center or dispatcher, the sensing of an emergency vehicle's identification may be tracked to enable the dispatcher to keep track of where each of the department's vehicles are located at any given moment. In this regard, a dispatcher could issue instructions to specific vehicles and/or traffic signals in response to nearby emergency situations.

In other embodiments, various preventative methods may be employed to reduce fraudulent use of the RF tags. For example, the RFID tags can be integrated into molded plastic frames that house the vehicle plates, thereby making it difficult to remove the RF tag. Alternatively, RFID tags may be attached to, or integrated with, the license plate, applied to an exterior surface of a vehicle or even mounted on a known or unknown internal or hidden surface of the vehicle, out of sight of the public. The RFID tags report only a unique and registered identifying number which, by itself, would be meaningless if stolen, as all the vehicle and owner-specific information associated with the identifying number data is preferably stored in a central database. Thus, if an RF tag was lost or stolen, that number could be disabled and rendered completely useless by a scanner, such as by erasing or writing over any information stored in a memory portion of the RFID tag or flagged as “stolen” to aid in its recovery. As an added security measure, the present invention may be adapted to cause the RF tag to be disabled, if removed by an unauthorized person.

In its finished form, a passive RFID tag is generally small, rugged and unobtrusive, which allows it to be permanently installed into devices and equipment by any number of convenient means. For example, the RFID tag may be sewn into the hem or seam of a wearer's clothing without adversely affecting either the clothing or the operation of the RFID tag. In this implementation of the invention, additional security may be provided in the form of automatic identification of an officer, thereby reducing the ability for one to improperly impersonate an officer.

In one embodiment of the present invention, each officer is issued a personal RFID tag containing a pass code needed to access a secured area or activate a police computer system, giving the officer access to a secured database 200 (see generally FIG. 5). In one embodiment the “secured area” may be a police vehicle. When the officer leaves the proximity of an assigned police vehicle 10 (see generally FIG. 2), the scanner 16 and associated equipment (see generally FIGS. 6 and 7) in the police car is disabled until the presence of the RFID tag worn by the authorized officer is detected. Thus, only while the officer is in police car and is within the scan range of scanner 16, does the scanner, processor 24 and associated equipment remain operational. This security feature thus prevents access to RFID tag 18 data and/or database 200 by unauthorized personnel.

Similarly, RFID tags may be embedded in children's' clothing and associated with the wearer. In the event that the child becomes lost, such as in a store or shopping mall, scanners located about the store or mall could be used to track and locate the child. A display or computerized voice messaging system linked to the scanners could provide look-up capabilities to help parents and authorities to find lost children.

In yet another embodiment, the present invention may be used at or near a political subdivision border crossing. By applying an RFID tag into a visitor's passport or with the issuance of a personal identification card, and with an association of the person's biometric data, a positive identification of the individual can be achieved. With this method of identification individuals can be tracked while visiting a political subdivision, such as a country.

In still other embodiments a scanner may be conveniently placed at the receiving entrance or loading/unloading dock for a desired location, such as a customs office, toll gate or border crossings. Scanners can be placed near a doorframe, at loading docks, and cargo openings on airplanes and ships at airports or seaports. Packages being shipped may be carried proximate the scanner, which automatically detects and reads the RFID tags of all labeled materials within a sealed shipping container.

The RFID tag may also be affixed inside any number of objects, such as electronic equipment, and small hand held devices, such as cell phones and other appliances. The tag may also be placed within the packaging for a wide variety of valuable articles, such as laptop computers or even made part of the labeling for certain products where it is printed under a bar code tag or paper label. In one embodiment, an RFID tag is integrated into an optically coded bar code label, enabling the label to be read by either or both optical and RFID scanning devices. The low relative cost of the RFID tags makes its use practical for use on all but the lowest-priced commodity articles.

With reference again to FIG. 5, the information stored in records at step 110 may include demographic information relating to owners, such as age and gender, and can be related to the vehicle of step 104 and the records of step 103. Demographic data about the vehicle can also be stored, such as, without limitation, vehicle age, make, model, type (e.g., sports car, convertible, luxury car, etc.), and country of origin. The demographic information can then be used to market specific products to the owners. In one embodiment a stationary scanner such as shown in FIG. 3 may be placed at a roadway such that demographic data can be collected and stored for RFID tag-equipped vehicles passing thereto. Based on weighted averages of the data using predetermined algorithms, the present invention can determine, for example, the proportions of men and women using that section of roadway and in what age groups they belong. Based on this information, a conventional electronic billboard placed in the vicinity of the scanner can be commanded to project predetermined advertisements specifically targeting desired demographics, such as vehicle type or age, and owner gender and/or age group. As an example, if a high proportion of drivers stopped at a red light are predominantly women, the electronic billboard advertising could target that demographic segment with a “makeup” or “diamonds are forever” advertisement. This type of advertising could even be extended to contacting owners directly via owners' cellular phones and Personal Digital Assistants (“PDAs”) or in-car navigation systems, marketing, for example, hotels or landmarks. The advertisements can thus be proactively queued by advertisers to the “captive” targeted audiences viewing the billboard. Advertising feedback data such as audience viewing time can also be generated by the system, by tracking the amount of time an RFID tag is proximate the scanner (see step 106). This involuntary audience participation information collected during a congested morning or evening commute could be sold by the political subdivision (e.g., a city or state) to advertisers, in addition to the advertising charges, providing the political subdivision with an added source of revenue that can be used to, for example, build and maintain roads. In another example, the present invention can obtain demographic information relating to owners and vehicles indicating that they are not locally-based, having, for example an out-of state home address. In this case the electronic billboard can be commanded to project room rates for nearby hotels, room availability, amenities, restaurants, tourist attractions such as zoos and amusement parks, telephone numbers for viewers to call to buy tickets to attractions, dates and times of scheduled events such as nearby concerts of interest to a particular gender and/or age group, and so on. The electronic billboard functions as a “smart” billboard, regularly changing the advertising display to target the demographics of the current audience.

With continued reference to FIG. 5, an example implementation of the smart billboard according to an embodiment of the present invention is depicted in FIG. 8. At step 201 a scanner located proximate a roadway detects RFID tags integrated to passing vehicles and/or RFID tags carried by passengers, such as in a credit card. Database 200 (see FIG. 5) is queried at step 202 to relate the identification number of the RFID tag to one or more records stored in the database. Once related records are located, demographic data is extracted from the records at step 204 and accumulated at step 206. At step 208 the accumulated demographic data is compared to related data in a predetermined set of algorithms 210 to select display data comprising an optimum targeted advertisement from a group of available advertisements. Once the display data is selected, the advertisement is displayed on an electronic billboard at step 212 to vehicle owners, e.g., drivers and occupants of the RFID tag-equipped vehicles. Operational data relating to the advertising may be accumulated at steps 214 and 216. At step 214 statistical data is accumulated relating to the frequency and amount of time each advertisement in a predetermined group of advertisements is displayed. At step 216 statistical data is accumulated relating to the amount of viewing time for passengers in RFID tag-equipped vehicles, based on the amount of time the scanner is able to detect the tag. The information of steps 206, 214 and 216 can be used for various statistical and analytical purposes including, without limitation, to charge advertisers based on amount of viewing time and/or frequency, and sell advertising based on prevalent demographics for that area of roadway.

While this invention has been shown and described with respect to a detailed embodiment thereof, it will be understood by those skilled in the art that changes in form and detail thereof may be made without departing from the scope of the claims of the invention. For example, the arrangement of systems and equipment to carry out the steps of the present invention is conventional, and is thus left to the artisan. In addition, the various steps detailed herein may be varied, rearranged, augmented, deleted and combined within the scope of the invention.

1. A system for registering and tracking vehicles, comprising:
an RFID tag affixed to a vehicle; and
a scanner,
wherein the scanner is adapted to query the RFID tag when proximate the RFID tag, effective to obtain information relating to at least one of the vehicle and an owner of the vehicle.

2. The system of claim 1 wherein the scanner is mounted in a second vehicle.

3. The system of claim 1 wherein the scanner is mounted proximate a road, effective to query RFID tags affixed to vehicles passing the scanner.

4. The system of claim 3 wherein the information is transmitted and stored in a database.

5. The system of claim 1 wherein the system further comprises a processor and a telecommunication link effective to permit the processor to send information to, and receive information from, a remotely-located database via the telecommunication link.

6. The system of claim 5, further comprising a second processor coupled to the telecommunication link.

7. The system of claim 5, further comprising a second database proximate the processor.

8. The system of claim 7, further comprising a second processor coupled to the telecommunication link.

9. A system for tracking vehicles, comprising:
an RFID tag affixed to a vehicle; and
a parking meter having a scanner,
wherein the scanner is adapted to query the RFID tag when proximate thereto, effective to obtain information relating to at least one of the vehicle and an owner of the vehicle,
and wherein the parking meter generates a citation if the vehicle remains proximate the scanner after a predetermined period of time has elapsed.

10. The system of claim 9 wherein the citation information is transmitted to a remote site using a telecommunication link.

11. The system of claim 10 wherein the owner of the vehicle receives the citation via the telecommunication link.

12. The system of claim 11 wherein the owner of the vehicle pays a fine associated with the citation via the communication link.

13. The system of claim 12 wherein the fine is automatically debited from a financial account held by the owner of the vehicle.

14. A method for registering and tracking vehicles, comprising the steps of:
coding an RFID tag with a unique identifier;
integrating the RFID tag with a vehicle;
creating a database with a record of information relating to at least one of the vehicle and an owner of the vehicle;
associating the record with the unique identifier;
querying the vehicle's RFID tag with a scanner to obtain the unique identifier;
using the unique identifier to obtain the record from the database; and
responding to the query with information in the record.

15. The method of claim 14, further comprising the step of populating the database with information of interest to a political subdivision.

16. The method of claim 14, further comprising the step of displaying information for visual verification.

17. The method of claim 14, further comprising the step of providing warnings and additional instructions.

18. The method of claim 14, further comprising the step of undertaking remedial action.

19. The method of claim 14, further comprising the step of updating the database.

20. The method of claim 14 wherein:
the vehicle is an emergency vehicle,
the RFID tag is queried as the emergency vehicle approaches a traffic signal, and
the traffic signal is caused to halt traffic and allow the emergency vehicle to pass.

21. The method of claim 20, further comprising the step of using the RFID tag and scanner to track the location of the emergency vehicle.

22. The method of claim 14, further comprising the step of disabling the RFID tag with the scanner.

23. A system for tracking objects, comprising:
an RFID tag affixed to an object; and
a scanner,
wherein the scanner is adapted to query the RFID tag when proximate the RFID tag, effective to obtain information relating to the object.

24. The system of claim 23, wherein the object is a bar-code label.

25. The system of claim 23, wherein the object is clothing.

26. The system of claim 23 wherein the RFID tag includes a pass code.

27. The system of claim 26 wherein the pass code is effective to activate equipment.

27. The system of claim 26 wherein the pass code is effective to provide access to a secured area.

28. The system of claim 23 wherein the system is used to locate a person carrying the object.

29. The system of claim 23 wherein the system is used to identify the person carrying the object.

30. The system of claim 23 wherein the system is used to track the location of the object.

31. A method for displaying targeted information, comprising the steps of:
coding an RFID tag with a unique identifier;
integrating the RFID tag with a vehicle;
creating a database with a record of information relating to at least one of the vehicle and an owner of the vehicle;
associating the record with the unique identifier;
querying the vehicle's RFID tag with a scanner to obtain the unique identifier;
using the unique identifier to obtain the record from the database;
comparing information in the record with related information in an algorithm;
selecting display data relevant to at least one of the vehicle and the owner based on the comparison; and
displaying the selected data on a display visually perceivable by the owner.

32. The method of claim 31, further comprising the steps of:
querying a plurality of vehicles' RFID tags with the scanner to obtain the unique identifiers;
using the unique identifiers to obtain a plurality of records;
accumulating information in the records; and
comparing the accumulated information with the related information in the algorithm to select the display data.

33. The method of claim 31, further comprising the step of accumulating statistical information relating to display of the selected display data.

34. The method of claim 31, further comprising the step of accumulating statistical information relating to the amount of time the selected display data is viewed by occupants of the vehicle.

35. The method of claim 31 wherein the selected display data is advertising.

36. The method of claim 31, wherein the selected display data is displayed on an electronic billboard.

37. The method of claim 31, further including the step of directly contacting the owner of the vehicle.
